(19) United States
(12) Patent Application Publication
(10) Pub. No.: US 2026/0034687 A1
(43) Pub. Date: Feb. 5, 2026

(54) Industrial Robot

(71) Applicant: ABB Schweiz AG, Baden (CH)

(72) Inventors: Tomas Botold, Västerås (SE); Jiangwei Huang, Västerås (SE); Shanghua Li, Västerås (SE); Johan Ernlund, Västerås (SE); LiWei Qi, Västerås (SE)

(21) Appl. No.: 19/100,298

(22) PCT Filed: Aug. 15, 2022
(86) PCT No.: PCT/EP2022/072768

§ 371 Date: Jan. 31, 2025

(51) Int. Cl. B25J 19/00

(52) U.S. Cl. CPC B25J 19/0054

(57) ABSTRACT

An industrial robot including a base; a manipulator movable relative to the base, the manipulator being hermetically closed and including a plurality of joints; a plurality of transmissions inside the manipulator, each transmission being associated with a unique joint; a plurality of motors inside the manipulator, each motor being arranged to drive a joint via the transmission associated with the joint; an outlet inside the manipulator distal of a distal transmission among the plurality of transmissions; a gas line passing between the base and the outlet; and a gas conducting structure configured to conduct a gas flow between the outlet and the base inside the manipulator, the gas conducting structure including, for each joint, at least one channel arranged to conduct the gas flow through the joint.

### TECHNICAL FIELD

The present disclosure generally relates to industrial robots. In particular, an industrial robot comprising a gas conducting structure is provided.

### BACKGROUND

Industrial robots are widely used for various purposes. An industrial robot typically comprises a plurality of links and a plurality of joints between the links. By driving a joint, one link can move relative to another link. To this end, each joint typically comprises a gearbox and an electric motor arranged to drive the joint via the gearbox. Each set of electric motor and gearbox is often positioned externally with respect to a housing of the industrial robot. In these cases, the electric motor and the gearbox can easily be accessed, such as for maintenance.

Some industrial robots comprise electric motors and gearboxes inside the housing. This may for example be desired when the industrial robot operates in a hygienic environment where the industrial robot should not cause contaminations. Examples of such hygienic environments comprise processing environments for food, beverages or pharmaceuticals. In such hygienic environments, the industrial robot may also need to withstand harsh washdown environments. Also for this reason, it is advantageous if the electric motors and gearboxes are located inside the housing to reduce a risk of corrosion of these components. Industrial robots comprising electric motors and gearboxes inside a housing are previously known.

JP H07246587 A discloses an industrial robot comprising a base, an end effector, a plurality of joints and a plurality of links. The links form a housing. A plurality of motors and a speed reducer are arranged inside the housing. An internal air hose passes from the base to the end effector. The air hose comprises a branch outlet at each motor.

For an industrial robot comprising motors and transmissions arranged in an interior region inside a hermetically closed manipulator, there is a risk that the temperature rises more quickly in comparison with an interior region in a manipulator that is not hermetically closed. Such hermetically closed manipulator therefore puts higher requirements on a cooling performance of the industrial robot. If the cooling is not sufficient, there is a risk that the industrial robot has to be driven at lower speeds and/or has to operate in cool environments.

### SUMMARY

One object of the invention is to provide an improved industrial robot. This object is achieved by the industrial robot according to appended claim 1.

The invention is based on the realization that by providing a hermetically sealed manipulator having a gas conducting structure comprising at least one channel for a gas flow associated with each joint and arranged to conduct the gas flow through the joint to control a temperature of a transmission of the joint, the industrial robot can be driven fast while maintaining target temperatures of the transmissions despite the manipulator being hermetically sealed. Thus, the performance of the industrial robot can be improved.

According to a first aspect, there is provided an industrial robot comprising a base; a manipulator movable relative to the base, the manipulator being hermetically closed and comprising a plurality of joints; a plurality of transmissions inside the manipulator, each transmission being associated with a unique joint; a plurality of motors inside the manipulator, each motor being arranged to drive a joint via the transmission associated with the joint; an outlet inside the manipulator distal of a distal transmission among the plurality of transmissions; a gas line passing between the base and the outlet; and a gas conducting structure configured to conduct a gas flow between the outlet and the base inside the manipulator, the gas conducting structure comprising, for each joint, at least one channel arranged to conduct the gas flow through the joint.

By conducting the gas flow through the at least one channel associated with a joint, a temperature of the transmission associated with the joint can be controlled. The gas conducting structure enables an efficient climate control of an interior region inside the manipulator. In particular, the gas conducting structure enables a very efficient cooling of the transmission. The cooling allows the industrial robot to be configured as a hygienic robot while still being able to run as fast as other non-hygienic robots.

The gas conducting structure may be configured to conduct the gas flow from the outlet to the base inside the manipulator. As a possible alternative, the gas conducting structure may be configured to conduct the gas flow in an opposite direction, i.e. from the base to the outlet and into the gas line.

The gas conducting structure also enables efficient heating and dehumidification of the interior region. For example, by providing a heated gas flow, the industrial robot can reliably operate in extremely cold environments.

The principle of operation of the gas conducting structure enables the at least one channel to be optimized for each joint. For example, the at least one channel may be designed to provide a relatively low speed of the gas flow for a joint requiring a high cooling effect, and vice versa. For each joint, the at least one channel may be arranged to conduct the gas flow along a surface of the transmission associated with the joint. For each joint, the at least one channel may comprise a plurality of channels.

The manipulator may comprise a hermetically closed housing containing the interior region. In this case, the transmissions, the motors, the outlet, the gas line and the gas conducting structure may be arranged inside this housing. With a hermetically closed housing is meant that fluid is at least to a very large extent prevented from moving between an exterior region outside the manipulator to the interior region.

At the outlet, the gas flow may exit the gas line into the interior region. The gas line may be a hose. The gas line may pass between the base and the outlet inside the manipulator.

The manipulator may comprise at least three programmable joints, such as six or seven programmable joints. The manipulator may be a serial manipulator. The base may be fixed to an external structure, such as a floor or a wall.

Each transmission may be a gearbox. The distal transmission may be a most distal transmission, i.e. a transmission associated with a most distal joint of the manipulator. As used herein, a distal direction is a direction along the manipulator towards an end effector thereof, and a proximal direction is a direction along the manipulator towards the base.

Each motor may be an electric motor. The outlet may be an end opening of the gas line. Each channel may comprise one opening in two or more different components of the manipulator. Alternatively, or in addition, the at least one channel for each joint may comprise a plurality of parallel channels.

For each joint, each channel may be positioned at a distance from a rotation axis of the joint that is at least 30% of a radial dimension of the joint. For at least one joint, each channel associated with the joint may be positioned at a distance from the rotation axis of the joint that is at least 50% of the radial dimension of the joint. For each joint, the radial dimension is a dimension in a radial direction with respect to a rotation axis of the joint.

The at least one channel may be arranged to conduct the gas flow along an outside of the transmission associated with the joint. An outside surface of the transmission of a joint may face away from the rotation axis of that joint.

The industrial robot may comprise an attachment interface. In this case, the outlet may be positioned adjacent to the attachment interface distal of a transmission associated with a joint for driving the attachment interface. The attachment interface may be a tool flange.

The attachment interface may comprise a collar enclosing the outlet. The collar may be fixed to, such as directly fixed to, an output gear of the transmission associated with the joint for driving the attachment interface.

The collar may comprise one or more radial through holes for conducting the gas flow. The radial through holes may be radial with respect to a rotation axis of the joint for driving the attachment interface.

Each transmission may be hollow. In this case, the gas line may pass through each transmission.

Each transmission may comprise a transmission flange. In this case, each transmission flange may comprise at least one transmission through hole forming part of the at least one channel. Each transmission flange may protrude radially outwards with respect to a rotation axis associated with the transmission. The transmission through holes may be substantially parallel with, or parallel with, the rotation axis.

For each joint, the transmission through holes may be distributed in a circumferential direction around a rotation axis of that joint. For each joint, some or all of the transmission through holes may be positioned at the same, or substantially the same, radial distance from the rotation axis of that joint. Alternatively, or in addition, for each joint, some or all of the transmission through holes may be positioned in a common plane transverse to the rotation axis of that joint.

The industrial robot may comprise a plurality of links between the joints. In this case, each link may comprise at least one link through hole forming part of the at least one channel. The link through holes may be substantially parallel with, or parallel with, the rotation axis.

For each joint, the link through holes may be distributed in a circumferential direction around a rotation axis of that joint. For each joint, some or all of the link through holes may be positioned at the same, or substantially the same, radial distance from the rotation axis of that joint. Alternatively, or in addition, for each joint, some or all of the link through holes may be positioned in a common plane transverse to the rotation axis of that joint.

Each link may comprise a link flange. In this case, each link flange may comprise some or all of the at least one link through hole. Each link flange may protrude radially inwards with respect to a rotation axis associated with the transmission. For each joint, a link flange may be fixed to a transmission flange, such as directly fixed thereto.

For each pair of a motor and a transmission associated with a joint, the transmission may be arranged upstream of the motor with respect to the gas flow.

The industrial robot may comprise, for at least one joint, a temperature sensor associated with the joint.

The industrial robot may comprise a gas source configured to deliver pressurized gas into the gas line.

The industrial robot may be configured to control the gas source based on a temperature measured by the at least one temperature sensor.

### BRIEF DESCRIPTION OF THE DRAWINGS

Further details, advantages and aspects of the present disclosure will become apparent from the following description taken in conjunction with the drawings, wherein:

FIG. 1: schematically represents a side view of an industrial robot;

FIG. 2: schematically represents a cross-sectional side view of the industrial robot;

FIG. 3: schematically represents a cross-sectional side view of a joint of the industrial robot; and

FIG. 4: schematically represents a cross-sectional side view of a further joint of the industrial robot.

### DETAILED DESCRIPTION

In the following, an industrial robot comprising a gas conducting structure, will be described. The same or similar reference numerals will be used to denote the same or similar structural features.

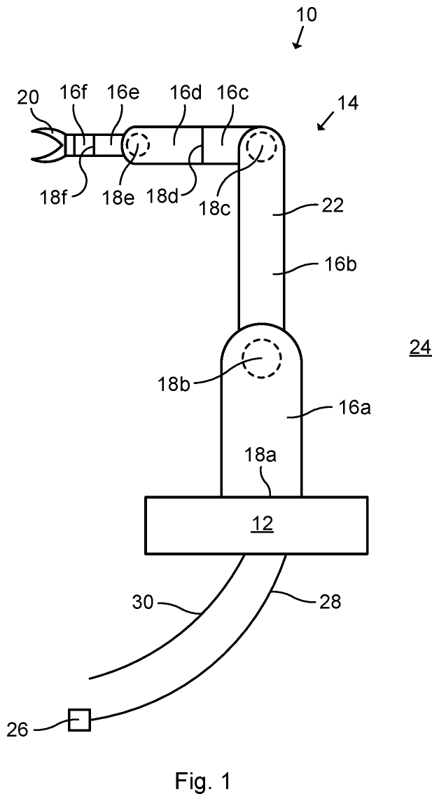

FIG. 1 schematically represents a side view of an industrial robot 10. The industrial robot 10 is a so-called hygienic robot, here a food processing robot. The industrial robot 10 comprises a base 12. The industrial robot 10 further comprises a manipulator 14 movable relative to the base 12.

The manipulator 14 of this specific and non-limiting example comprises a first link 16a rotatable relative to the base 12 at a first joint 18a, a second link 16b rotatable relative to the first link 16a at a second joint 18b, a third link 16c rotatable relative to the second link 16b at a third joint 18c, a fourth link 16d rotatable relative to the third link 16c at a fourth joint 18d, a fifth link 16e rotatable relative to the fourth link 16d at a fifth joint 18e, and a sixth link 16f rotatable relative to the fifth link 16e at a sixth joint 18f. In this example, the sixth link 16f is a tool flange. Reference numeral “16f” may thus be used interchangeably for the sixth link and the tool flange. The tool flange 16f is one example of an attachment interface according to the present disclosure.

One, several or all of the joints 18a-18f may also be referred to with reference numeral “18”. The manipulator 14 may alternatively comprise fewer than, or more than, the six joints 18. One, several or all of the links 16a-16f may also be referred to with reference numeral “16”.

The manipulator 14 further comprises an end effector 20 connected to the tool flange 16f. The end effector 20 is here exemplified as a gripper. The end effector 20 is connected at a distal end of the manipulator 14. The base 12 is provided at a proximal end of the manipulator 14.

The manipulator 14 comprises a hermetically closed housing 22. The manipulator 14 thus provides a tight enclosure for the components inside. The housing 22 comprises the base 12, the links 16 and seals between the links 16. Each link 16 is in this specific and non-limiting example made of stainless steel. Each link 16 may for example alternatively be made of plastic or aluminum. The housing 22 separates an exterior region 24 outside the manipulator 14 from an interior region inside the manipulator 14.

The industrial robot 10 further comprises a gas source 26. The gas source 26 is configured to supply pressurized gas to the interior region inside the manipulator 14. The gas source 26 of this example is configured to supply pressurized air.

As shown, the industrial robot 10 also comprises a hose 28 for conducting the air from the gas source 26 into the manipulator 14. The hose 28 is led into the base 12 and then further into the housing 22. The hose 28 is one example of a gas line according to the present disclosure.

The industrial robot 10 further comprises an outlet line 30. The outlet line 30 is configured to conduct air out from the interior region. The outlet line 30 here leaves the manipulator 14 at the base 12. The gas source 26 and an outlet of the outlet line 30 may be positioned outside a food processing area, such as in another room with respect to a room in which the manipulator 14 operates.

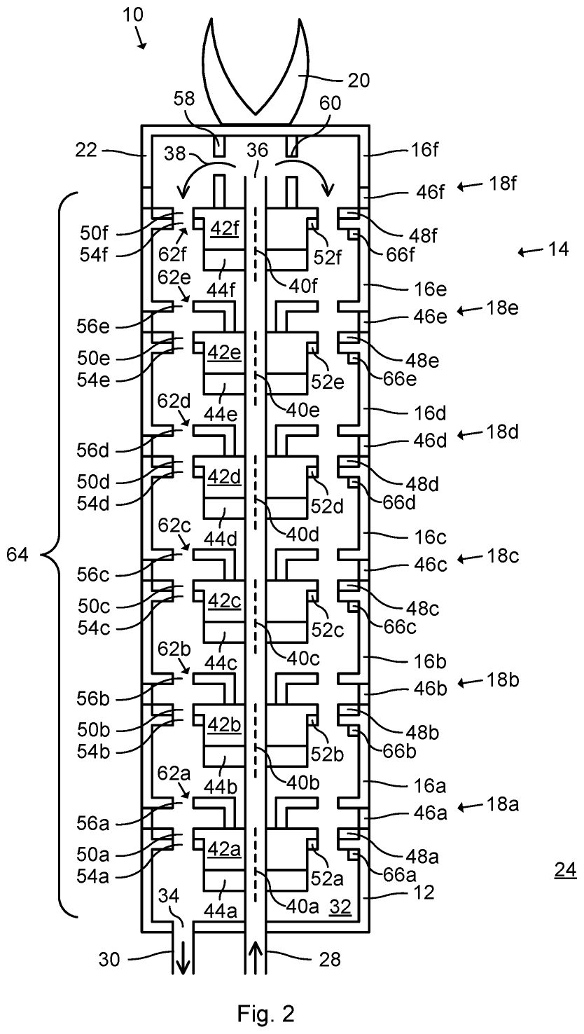

FIG. 2 schematically represents a cross-sectional side view of the industrial robot 10. In FIG. 2, the interior region 32 inside the manipulator 14 can be seen. In this example, the air can only enter the interior region 32 via the hose 28 and can only leave the interior region 32 via the outlet line 30. The industrial robot 10 comprises a base outlet opening 34 in the base 12. Air in the interior region 32 in the base 12 enters the outlet line 30 via the base outlet opening 34.

The hose 28 comprises an outlet 36. As illustrated with arrows, a gas flow 38 leaves the hose 28 at the outlet 36. The gas flow 38 is here exemplified as an air flow. The outlet 36 is here positioned at a distal end of the hose 28. In this example, the outlet 36 is positioned in the interior region 32 distal of the most distal joint 18 (here the sixth joint 18f). The hose 28 is led from the base 12 and continues inside the interior region 32 through the first joint 18a, the second joint 18b, the third joint 18c, the fourth joint 18d, the fifth joint 18e and the sixth joint 18f until the hose 28 reaches the tool flange 16f. The gas flow 38 from the outlet 36 is led proximally inside the manipulator 14 to the base 12.

In this specific and non-limiting example, the first link 16a is rotatable relative to the base 12 about a first rotation axis 40a, the second link 16b is rotatable relative to the first link 16a about a second rotation axis 40b, the third link 16c is rotatable relative to the second link 16b about a third rotation axis 40c, the fourth link 16d is rotatable relative to the third link 16c about a fourth rotation axis 40d, the fifth link 16e is rotatable relative to the fourth link 16d about a fifth rotation axis 40e, and the tool flange 16f is rotatable relative to the fifth link 16e about a sixth rotation axis 40f. One, several or all of the rotation axes 40a-40f may also be referred to with reference numeral “40”.

The first joint 18a comprises a first gearbox 42a and a first motor 44a arranged to drive the first joint 18a via the first gearbox 42a. The second joint 18b comprises a second gearbox 42b and a second motor 44b arranged to drive the second joint 18b via the second gearbox 42b. The third joint 18c comprises a third gearbox 42c and a third motor 44c arranged to drive the third joint 18c via the third gearbox 42c. The fourth joint 18d comprises a fourth gearbox 42d and a fourth motor 44d arranged to drive the fourth joint 18d via the fourth gearbox 42d. The fifth joint 18e comprises a fifth gearbox 42e and a fifth motor 44e arranged to drive the fifth joint 18e via the fifth gearbox 42e. The sixth joint 18f comprises a sixth gearbox 42f and a sixth motor 44f arranged to drive the sixth joint 18f via the sixth gearbox 42f.

One, several or all of the gearboxes 42a-42f may also be referred to with reference numeral “42”. The gearboxes 42 are examples of transmissions according to the present disclosure. One, several or all of the motors 44a-44f may also be referred to with reference numeral “44”. Each motor 44 is here exemplified as an electric motor. As shown in FIG. 2, each gearbox 42 and each motor 44 is arranged in the interior region 32 inside the housing 22.

The manipulator 14 of this specific and non-limiting example further comprises a first seal 46a sealing between the first link 16a and the base 12 at the first joint 18a, a second seal 46b sealing between the second link 16b and the first link 16a at the second joint 18b, a third seal 46c sealing between the third link 16c and the second link 16b at the third joint 18c, a fourth seal 46d sealing between the fourth link 16d and the third link 16c at the fourth joint 18d, a fifth seal 46e sealing between the fifth link 16e and the fourth link 16d at the fifth joint 18e, and a sixth seal 46f sealing between the tool flange 16f and the fifth link 16e at the sixth joint 18f. One, several or all of the seals 46a-46f may also be referred to with reference numeral “46”.

In the manipulator 14 of this specific and non-limiting example, the first gearbox 42a comprises a first transmission flange 48a, the second gearbox 42b comprises a second transmission flange 48b, the third gearbox 42c comprises a third transmission flange 48c, the fourth gearbox 42d comprises a fourth transmission flange 48d, the fifth gearbox 42e comprises a fifth transmission flange 48e, and the sixth gearbox 42f comprises a sixth transmission flange 48f. One, several or all of the transmission flanges 48a-48f may also be referred to with reference numeral “48”. Each transmission flange 48 here protrudes radially outwards with respect to the associated rotation axis 40 and lies in a plane transverse to the associated rotation axis

The first transmission flange 48a comprises a plurality of first transmission through holes 50a, the second transmission flange 48b comprises a plurality of second transmission through holes 50b, the third transmission flange 48c comprises a plurality of third transmission through holes 50c, the fourth transmission flange 48d comprises a plurality of fourth transmission through holes 50d, the fifth transmission flange 48e comprises a plurality of fifth transmission through holes 50e, and the sixth transmission flange 48f comprises a plurality of sixth transmission through holes 50f. One, several or all of the transmission through holes 50a-50f may also be referred to with reference numeral “50”. For each joint 18, the transmission through holes 50 are positioned at the same radial distance from the rotation axis 40 of that joint 18.

The base 12 comprises a first link flange 52a, the first link 16a comprises a second link flange 52b, the second link 16b comprises a third link flange 52c, the third link 16c comprises a fourth link flange 52d, the fourth link 16d comprises a fifth link flange 52e, and the fifth link 16e comprises a sixth link flange 52f. One, several or all of the link flanges 52a-52f may also be referred to with reference numeral “52”. Each link flange 52 here protrudes radially inwards with respect to the associated rotation axis 40 and lies in a plane transverse to the associated rotation axis 40. Moreover, each link flange 52 is directly fixed to a respective transmission flange 48.

The first link flange 52a comprises a plurality of first proximal link through holes 54a, the second link flange 52b comprises a plurality of second proximal link through holes 54b, the third link flange 52c comprises a plurality of third proximal link through holes 54c, the fourth link flange 52d comprises a plurality of fourth proximal link through holes 54d, the fifth link flange 52e comprises a plurality of fifth proximal link through holes 54e, and the sixth link flange 52f comprises a plurality of sixth proximal link through holes 54f. One, several of all of the proximal link through holes 54a-54f may also be referred to with reference numeral “54”.

In the manipulator 14 of this specific and non-limiting example, the first link 16a comprises a plurality of first distal link through holes 56a, the second link 16b comprises a plurality of second distal link through holes 56b, the third link 16c comprises a plurality of third distal link through holes 56c, the fourth link 16d comprises a plurality of fourth distal link through holes 56d, and the fifth link 16e comprises a plurality of fifth distal link through holes 56e. One, several or all of the distal link through holes 56a-56e may also be referred to with reference numeral “56”. For at least some joints 18 (here the first to fifth joints 18a-18f), the proximal link through holes 54 are proximal of the seal 46 associated with the joint 18 and the distal link through holes 56 are distal of the seal 46 associated with the joint 18. For at least some joint 18, the link through holes 54 and 56 are positioned at the same radial distance from the rotation axis 40 of that joint 18.

The tool flange 16f of this example comprises a collar 58. The collar 58 is here cylindrical and concentric with the sixth rotation axis 40f. The collar 58 comprises a plurality of radial through holes 60 (with respect to the sixth rotation axis 40f). The outlet 36 is here positioned inside the collar 58. The radial through holes 60 may be said to constitute distal link through holes with respect to the sixth joint 18f.

The manipulator 14 of this specific and non-limiting example comprises first channels 62a associated with the first joint 18a, second channels 62b associated with the second joint 18b, third channels 62c associated with the third joint 18c, fourth channels 62d associated with the fourth joint 18d, fifth channels 62e associated with the fifth joint 18e, and sixth channels 62f associated with the sixth joint 18f. One, several or all of the channels 62a-62f may also be referred to with reference numeral “62”.

The first channels 62a are arranged to conduct the gas flow 38 through the first joint 18a to control a temperature of the first gearbox 42a. The first channels 62a of this example comprise the first distal link through holes 56a, the first transmission through holes 50a and the first proximal link through holes 43a.

The second channels 62a are arranged to conduct the gas flow 38 through the second joint 18b to control a temperature of the second gearbox 42b. The second channels 62b of this example comprise the second distal link through holes 56b, the second transmission through holes 50b and the second proximal link through holes 54b.

The third channels 62c are arranged to conduct the gas flow 38 through the third joint 18c to control a temperature of the third gearbox 42c. The third channels 62c of this example comprise the third distal link through holes 56c, the third transmission through holes 50c and the third proximal link through holes 54c.

The fourth channels 62d are arranged to conduct the gas flow 38 through the fourth joint 18d to control a temperature of the fourth gearbox 42d. The fourth channels 62d of this example comprise the fourth distal link through holes 56d, the fourth transmission through holes 50d and the fourth proximal link through holes 54d.

The fifth channels 62e are arranged to conduct the gas flow 38 through the fifth joint 18e to control a temperature of the fifth gearbox 42e. The fifth channels 62e of this example comprise the fifth distal link through holes 56e, the fifth transmission through holes 50e and the fifth proximal link through holes 54e.

The sixth channels 62f are arranged to conduct the gas flow 38 through the sixth joint 18f to control a temperature of the sixth gearbox 42f. The sixth channels 62f of this example comprise the radial through holes 60, the sixth transmission through holes 50f and the sixth proximal link through holes 54f.

The channels 62 form one example of a gas conducting structure 64 according to the present disclosure. The hose 28 is guided in the interior region 32 from the base 12, through each gearbox 42 and to the tool flange 16f. The hose 28 is also guided in the interior region 32 from the base 12, by or through each motor 44 and to the tool flange 16f. The gas flow 38 is led from the outlet 36, through the gas conducting structure 64 and within the interior region 32 to the base 12. For each joint 18, the associated channels 62 are arranged to conduct the gas flow 38 through the joint 18 to control a temperature of the gearbox 42 associated with the joint 18.

In this example, for the sixth joint 18f, the gas flow 38 flows from the outlet 36, through the radial through holes 60, then through the sixth transmission through holes 50f, and then through the sixth proximal link through holes 54f. For each remaining joint 18a-18e, the gas flow 38 flows through the distal link through holes 56, then through the transmission through holes 50, and then through the proximal link through holes 54.

The industrial robot 10 of this example further comprises a first temperature sensor 66a at the first joint 18a, a second temperature sensor 66b at the second joint 18b, a third temperature sensor 66c at the third joint 18c, a fourth temperature sensor 66d at the fourth joint 18d, a fifth temperature sensor 66e at the fifth joint 18e, and a sixth temperature sensor 66f at the sixth joint 18f. One, several of all of the temperature sensors 66a-66f may also be referred to with reference numeral “66”. The temperature sensors 66 monitor the temperatures in each joint 18. The industrial robot 10 is configured to control the gas source 26 based on the temperatures measured by the temperature sensors 66.

The gearboxes 42, the motors 44 and the temperature sensors 66 are encapsulated inside the manipulator 14 and housing 22 and are protected by the manipulator 14. The gas source 26 can be controlled based on temperature readings from the temperature sensors 66. In this way, the gas flow 38 can be controlled to provide a desired heating or cooling of the components in the interior region 32, e.g. to maintain one or more target temperatures in the interior region 32.

Although the housing 22 made of stainless steel provides an improved resistance against corrosive washdown processes, there is a risk that the temperature in the interior region 32 will rise rapidly during movements of the manipulator 14 since stainless steel has a relatively low heat transfer coefficient. A too high temperature inside the manipulator 14 can damage components inside the manipulator 14. The gas conducting structure 64 according to the present disclosure provides a very efficient temperature control of the gearboxes 42, in particular cooling of the gearboxes 42. In contrast to prior art manipulators, the manipulator 14 can be hermetically sealed without having to compromise its performance.

The washdown processes also often generate a humid environment for the industrial robot 10. The gas flow 38 through the gas conducting structure 64 contributes to dehumidifying the air in the interior region 32. In this way, condensation issues can be avoided.

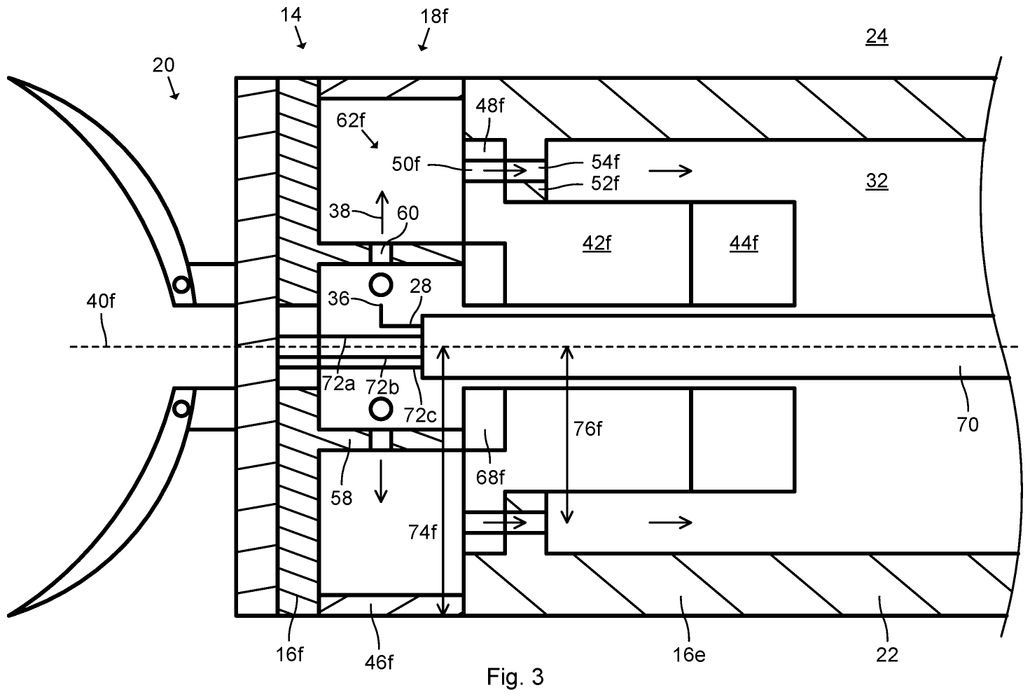

FIG. 3 schematically represents a cross-sectional side view of the sixth joint 18f. In FIG. 3, it can be seen that the sixth gearbox 42f comprises a sixth output gear 68f for driving the tool flange 16f. The sixth output gear 68f is here directly fixed to the collar 58. Since the tool flange 16f is sealingly closed to the exterior region 24 inter alia by the sixth seal 46f, the gas flow 38 has to move proximally out from the tool flange 16f within the interior region 32.

As shown in FIG. 3, the hose 28 is led inside a tube 70. In addition to the hose 28, the tube 70 may guide additional lines, such as a power and signal line 72a, an air input line 72b and an air output line 72c, to the end effector 20.

The sixth transmission through holes 50f and the sixth proximal link through holes 54f direct the gas flow 38 to the sixth gearbox 42f. The gas flow 38 here encloses the sixth gearbox 42f and provides a very efficient cooling thereof. The gas flow 38 here flows along an outside surface of the sixth gearbox 42f and cools the sixth gearbox 42f. The same gas flow 38 then flows by or through the sixth motor 44f and cools the sixth motor 44f.

FIG. 3 shows a sixth radial dimension 74f of the sixth joint 18f from the sixth rotation axis 40f to an exterior surface of the sixth joint 18f, here an exterior surface of the sixth seal 46f. A sixth distance 76f from the sixth rotation axis 40f to the sixth transmission through holes 50f and the sixth proximal link through holes 54f is here approximately 65% of the sixth radial dimension 74f.

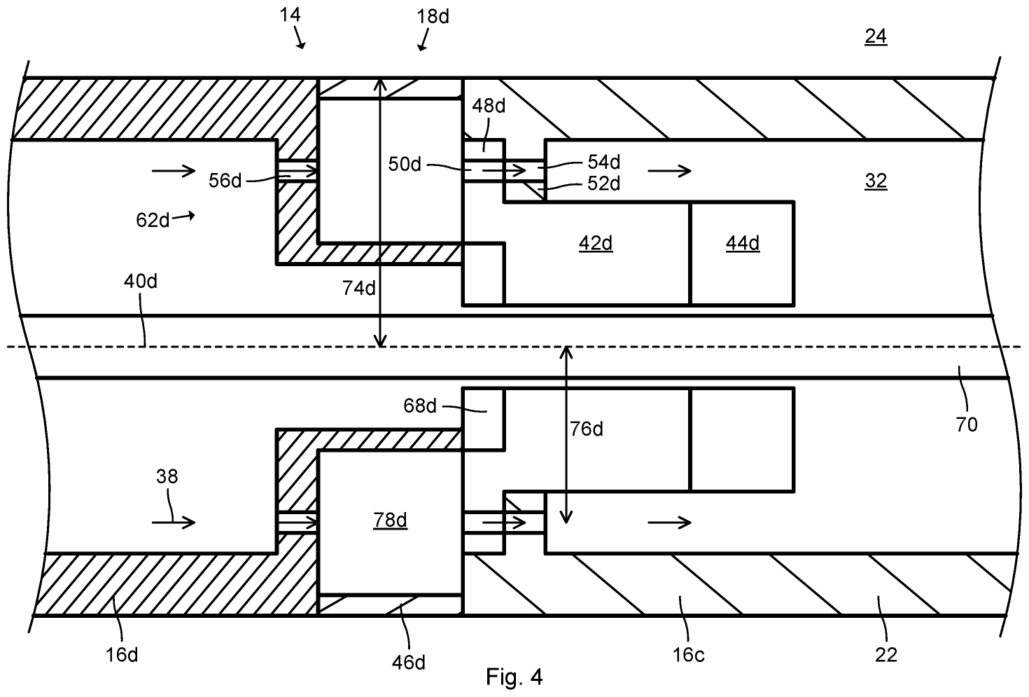

FIG. 4 schematically represents a partial cross-sectional side view of the fourth joint 18d. The references to the fourth joint 18d in FIG. 4 apply correspondingly to each of the first joint 18a, the second joint 18b, the third joint 18c and the fifth joint 18e.

In FIG. 4, it can be seen that the fourth gearbox 42d comprises a fourth output gear 68d for driving the fourth link 16d. The fourth output gear 68d is here directly fixed to the fourth link 16d.

The fourth transmission through holes 50d and the fourth proximal link through holes 54d direct the gas flow 38 to the fourth gearbox 42d. The gas flow 38 here encloses the fourth gearbox 42d and provides a very efficient cooling thereof. The gas flow 38 flows along an outside surface of the fourth gearbox 42d and cools the fourth gearbox 42d. The same gas flow 38 then flows by or through the fourth motor 44d and cools the fourth motor 44d.

FIG. 4 shows a fourth radial dimension 74d of the fourth joint 18d from the fourth rotation axis 40d to an exterior surface of the fourth joint 18d, here an exterior surface of the fourth seal 46d. A fourth distance 76d from the fourth rotation axis 40d to the fourth transmission through holes 50d and the fourth proximal link through holes 54d is here approximately 65% of the fourth radial dimension 74d. The gas flow 38 through a plurality of parallel fourth channels 62d and at the fourth distance 76d being at least 30% of the fourth radial dimension 74d enables a very efficient cooling of the fourth gearbox 42d.

As shown in FIG. 4, each set of a fourth distal link through hole 56d, a fourth transmission through hole 50d and a fourth proximal link through hole 54d forms a fourth channel 62d through the fourth joint 18d. Each fourth channel 62d thus comprises an opening in three different components, here the fourth link 16d, the fourth gearbox 42d and the third link 16c.

There is a fourth chamber 78d radially inside the fourth seal 46d. The fourth chamber 78d is annular and concentric with respect to the fourth rotation axis 40d. The gas flow 38 passes through the fourth chamber 78d. Due to the fourth chamber 78d, the fourth distal link through hole 56d and the fourth transmission through hole 50d do not have to be rotationally aligned around the fourth rotation axis 40d to transmit the gas flow 38.

The gas flow 38 flows by the fourth gearbox 42d and cools the fourth gearbox 42d. The same gas flow 38 then flows by or through the fourth motor 44d and cools the fourth motor 44d.

The gas flow 38 inside the manipulator 14 promotes heat dissipation from the hot gearboxes 42 and motors 44 to the housing 22. The gas flow 38 also keeps the components inside the housing 22 dry and reduce humidity in the interior region 32 to avoid condensation issues.

In some applications, the industrial robot 10 has to work in cold environments, such as at temperatures around −40° C. In such cases, the gas flow 38 can be heated before being led into the hose 28. When such heated gas flow 38 is led by the gas conducting structure 64, components in the interior region 32 can be efficiently heated, such as prior to performing any task by the manipulator 14. The industrial robot 10 thus enables temperatures in the interior region 32 to be efficiently controlled.

The gas flow 38 does not necessarily have to be active. That is, the gas flow 38 may be turned off in some situations. The gas flow 38 may be turned on to provide cooling also if only one joint 18 among all joints 18 has a too high temperature, as measured by the respective temperature sensor 66. Thus, according to one variant, the gas flow 38 is activated to cool the gearboxes 42 as long as the temperature of at least one joint 18 is above a target temperature.

The internal climate control provided by the gas conducting structure 64 is a very advantageous feature for the hygienic industrial robot 10 comprising the tight housing 22 of stainless steel that encapsulates key components. The gas conducting structure 64 enables the hygienic industrial robot 10 to operate at a performance equal to a performance of a non-hygienic robot despite being hermetically sealed.

Due to the gas flow 38, the interior region 32 can be kept dry and at a desired temperature. This for example reduces a risk of corrosion. The gas flow 38 thus contributes to extend the service lifetime of the industrial robot 10

The specific design of the channels 62 enables a very efficient cooling of the gearboxes 42. The design also enables an efficient dehumidification of the interior region 32 to avoid condensation issues. In some situations, the exterior region 24 is relatively humid. One example of such situation is when the industrial robot 10 handles vegetables. Due to the hermetically sealed housing 22 and due to the gas conducting structure 64, the industrial robot 10 can operate with high speed performance and high hygienic performance in humid environments. For example, corrosion inside the manipulator 14 and overheating of any of the gearboxes 42 can be avoided.

While the present disclosure has been described with reference to exemplary embodiments, it will be appreciated that the present invention is not limited to what has been described above. For example, it will be appreciated that the dimensions of the parts may be varied as needed. Accordingly, it is intended that the present invention may be limited only by the scope of the claims appended hereto.

1. An industrial robot comprising:
a base;
a manipulator movable relative to the base, the manipulator being hermetically closed and having a plurality of joints;
a plurality of transmissions inside the manipulator, each transmission being associated with a unique joint;
a plurality of motors inside the manipulator, each motor being arranged to drive a joint via the transmission associated with the joint;
an outlet inside the manipulator distal of a distal transmission among the plurality of transmissions;
a gas line passing between the base and the outlet; and
a gas conducting structure configured to conduct a gas flow between the outlet and the base inside the manipulator the gas conducting structure including, for each joint, at least one channel arranged to conduct the gas flow through the joint
wherein the at least one channel is arranged to conduct the gas flow along an outside of the transmission associated with the joint.

2. The industrial robot according to claim 1, wherein for each joint, each channel is positioned at a distance from a rotation axis of the joint that is at least 30% of a radial dimension of the joint.

3. (canceled)

4. The industrial robot according to claim 1, wherein the industrial robot comprises an attachment interface, and wherein the outlet) is positioned adjacent to the attachment interface distal of a transmission associated with a joint for driving the attachment interface.

5. The industrial robot according to claim 4, wherein the attachment interface comprises a collar enclosing the outlet.

6. The industrial robot according to claim 5, wherein the collar comprises one or more radial through holes for conducting the gas flow.

7. The industrial robot according to claim 1, wherein each transmission is hollow, and wherein the gas line passes through each transmission.

8. The industrial robot according to claim 1, wherein each transmission comprises a transmission flange, and wherein each transmission flange includes at least one transmission through hole forming part of the at least one channel.

9. The industrial robot according to claim 1, wherein the industrial robot comprises a plurality of links between the joints, and wherein each link includes at least one link through hole forming part of the at least one channel.

10. The industrial robot according to claim 9, wherein each link comprises a link flange, and wherein each link flange includes some or all of the at least one link through hole.

11. The industrial robot according to claim 1, wherein for each pair of a motor and a transmission associated with a joint, the transmission is arranged upstream of the motor with respect to the gas flow.

12. The industrial robot according to claim 1, wherein the industrial robot comprises, for at least one joint, a temperature sensor associated with the joint.

13. The industrial robot according to claim 12, wherein the industrial robot comprises a gas source configured to deliver pressurized gas into the gas line.

14. The industrial robot according to claim 12, wherein the industrial robot is configured to control the gas source based on a temperature measured by the at least one temperature sensor.

15. The industrial robot according to claim 1, wherein the at least one channel comprises a plurality of parallel channels for each joint

16. The industrial robot according to claim 2, wherein the industrial robot comprises an attachment interface, and wherein the outlet is positioned adjacent to the attachment interface distal of a transmission associated with a joint for driving the attachment interface.

17. The industrial robot according to claim 2, wherein each transmission is hollow, and wherein the gas line passes through each transmission.

18. The industrial robot according to claim 2, wherein each transmission comprises a transmission flange, and wherein each transmission flange includes at least one transmission through hole forming part of the at least one channel.

19. The industrial robot according to claim 2, wherein the industrial robot comprises a plurality of links between the joints, and wherein each link includes at least one link through hole forming part of the at least one channel.

20. The industrial robot according to claim 2, wherein for each pair of a motor and a transmission associated with a joint, the transmission is arranged upstream of the motor with respect to the gas flow.

21. The industrial robot according to claim 2, wherein the industrial robot comprises, for at least one joint, a temperature sensor associated with the joint.
